(19) United States
(12) Patent Application Publication
(10) Pub. No.: US 2026/0158683 A1
(43) Pub. Date: Jun. 11, 2026

(54) INSPECTION ROBOT WITH MODULAR COMPONENTS AND HIGH CONFIGURABILITY

(71) Applicant: Gecko Robotics, Inc., Pittsburgh, PA (US)

(72) Inventors: Michael A. Binger, Pittsburgh, PA (US); Alexander R. Cuti, Pittsburgh, PA (US); Dillon R. Jourde, Pittsburgh, PA (US); Ryan List, Beaver, PA (US); Edward A. Bryner, Pittsburgh, PA (US); Troy Demmer, Glenshaw, PA (US); Edwin H. Cho, Pittsburgh, PA (US); Samuel Theodore Westenberg, Portland, ME (US); Weronika van Vianen, Philadelphia, PA (US)

(21) Appl. No.: 19/409,460

(22) Filed: Dec. 4, 2025

Related U.S. Application Data
(63) Continuation of application No. PCT/US2024/033260, filed on Jun. 10, 2024.
(60) Provisional application No. 63/471,874, filed on Jun. 8, 2023.

(51) Int. Cl. B25J 19/00; B25J 9/08; B25J 11/00; B25J 19/02

(52) U.S. Cl. CPC B25J 19/0029; B25J 9/08; B25J 11/008; B25J 19/0054; B25J 19/02

(57) ABSTRACT

A device may include a motive power module comprising a motive power device and a magnetic engagement device, coupled to a core module comprising a tether connection, a peripheral module interface, a power management component, and a data acquisition (DAQ) module interface. A device may include a peripheral module coupled to the peripheral module interface, the peripheral module comprising power coupling and communications coupling, and for a selected payload. A device may include a DAQ module coupled to the DAQ module interface, the DAQ module comprising a data acquisition circuit configured to collect, store, and/or transmit data from the selected payload to an external device.

### CROSS-REFERENCE TO RELATED APPLICATIONS

This application claims benefit of and is a continuation of International Patent Application No. PCT/US 2024/033260 (Attorney Docket No. GROB-0022-WO), filed Jun. 10, 2024, and entitled “INSPECTION ROBOT WITH MODULAR COMPONENTS AND HIGH CONFIGURABILITY,” International Pub. No. WO 2024/254593, which is hereby incorporated by reference in its entirety for all purposes.

International Patent Application No. PCT/US2024/033260 claims the benefit of U.S. Provisional Patent App. No. 63/471,874, filed on 8 Jun. 2023, entitled “INSPECTION ROBOT WITH MODULAR COMPONENTS AND HIGH CONFIGURABILITY” (Attorney Docket No. GROB-0022-P01).

Each of the foregoing applications is incorporated herein in the entirety for all purposes.

### SUMMARY

Example embodiments utilize modular components that allow for rapid configuration, and/or on-site configuration, for particular operation(s). Further, embodiments herein allow for on-site follow-up inspections, and/or engineering an additional inspection, repair, and/or marking operation on-site within a single service trip to the service location. Example operations utilize sensors or other components (e.g., visualization, cleaning, marking, and/or repair components) that have a wide range of various aspects to support operations, such as: generated and/or collected data rates; data types; required power for operation; provision of supporting fluids such as couplant, cleaning fluids, marking fluids, and/or fluids utilized in repair operations; surface motive engagement assemblies; locating assemblies (e.g., to determine where the inspection robot is on a surface, determination of absolute position, direction, and/or speed of the inspection robot, and/or associating any of these with inspection data and/or supporting data such as pictures, identified obstacles, or the like); power and/or actuating control of supporting assemblies to position the inspection robot and/or portions thereof in a controllable and confirmable manner on the inspection surface; supporting processing for inspection operations, for example onboard processing to interpret raw sensor data into detected conditions of the inspection surface; and/or external communications to/from a base station, operator computing device, and/or cloud server, with communications including data, calibrations, status (e.g., of the inspection robot, the inspection surface, and/or operation level communications such as inspection coverage, progression, stage, etc.), and/or control. The complexity and variety of these supporting aspects present significant challenges to providing an inspection robot that can support a wide variety of operations. Embodiments herein support a wide range of potential applications, with an inspection robot that can be reconfigured by changing a small number of components (or modules) with limited and simplified interfaces. Embodiments herein support inspection robots that can be reconfigured with a small number of tools (e.g., a single wrench of a selected size), and/or in a challenging environment (e.g., in the field rather than in a shop, service location, and/or manufacturing facility, including in an environment with high humidity, dust, mud, rain, etc.), with high confidence that the re-configured inspection robot will be immediately operational without testing and/or with only limited testing (e.g., testing basic functionality from a base station, connected laptop, mobile application in communication with the inspection robot, etc.). Accordingly, embodiments herein support the capability to perform a broader range of services on a broader range of applications, with a single inspection robot and group of modules, than previously known, with significant reductions in costs to configure, reductions in turnaround time to prepare for operations, and/or to respond to conditions that are determined at the service location (e.g., where the determination is made upon visual inspection of the location, according to inspection operations performed at the service location, and/or determined en route to the location—for example reducing the time between a request for service and arrival at the service location by a service operator). Embodiments herein have selected modularity aspects—for example the content and distribution of specific modules—that are selected to support these capabilities and to meet consequent multiple competing goals, for example between: type and/or capability of operations supported; limiting interfaces that are exposed, broken, and/or re-connected during reconfiguration operations; providing a physical footprint that is appropriate for a range of applications and/or inspection surfaces; and/or capability to provide a number of modules within a selected space (e.g., a service truck, pickup bed, flat bed, service van, etc.) to provide a commercially valuable range of capabilities to meet service needs at a selected service location and/or group of service locations.

### BRIEF DESCRIPTION OF THE FIGURES

FIG. 1 depicts an example modular robotic system according to embodiments of the present disclosure.

FIG. 2 depicts an example modular robot system according to embodiments of the present disclosure.

FIG. 3 depicts an example core module according to embodiments of the present disclosure.

FIG. 4 depicts an example core module according to embodiments of the present disclosure.

FIG. 5 is a schematic depiction of an example modular robotic system according to embodiments of the present disclosure.

FIG. 6 depicts an example top view of a modular robotic system according to embodiments of the present disclosure.

FIG. 7 is a schematic depiction of an example motive power module according to embodiments of the present disclosure.

FIG. 8 depicts an example motive power module according to embodiments of the present disclosure.

FIG. 9 depicts an example side view of a modular robotic system according to embodiments of the present disclosure.

FIG. 10 depicts an example housing for a motive power device according to embodiments of the present disclosure.

FIG. 11 schematically depicts an encoder component according to embodiments of the present disclosure.

FIG. 12 depicts an example encoder component according to embodiments of the present disclosure.

FIG. 13 depicts another example of the encoder component according to embodiments of the present disclosure.

FIG. 14 depicts an example side perspective view of a modular robotic system according to embodiments of the present disclosure, in an assembled and exploded view.

FIG. 15 depicts an example perspective view of a modular robotic system according to embodiments of the present disclosure.

FIG. 16 depicts an example modular robotic system, with the motive power module, core module, and peripheral module depicted in the example.

FIG. 17 depicts an example motive power module according to embodiments of the present disclosure.

FIG. 18 depicts another view of the example motive power module according to embodiments of the present disclosure.

FIG. 19 depicts an example side perspective view of a modular robotic system according to embodiments of the present disclosure.

### DETAILED DESCRIPTION

Example embodiments herein include inspection robots that are highly configurable to support a broad range of inspection, surface visualization, surface marking, surface cleaning, and/or surface repair operations. Embodiments herein reference an inspection robot as a baseline term to describe a robot that can support any of these operations, including a subset of these operations, or all of these operations, for clarity of the present description. The specific operations performed may nevertheless not be “inspection” operations in certain configurations and/or while performing certain operations. Similarly, embodiments herein reference an inspection surface as a baseline term to describe a service location, and specifically the portion of the service location that is engaged by the inspection robot. An inspection surface, in certain embodiments, may be a serviced portion of the location, whether the specific service(s) performed include(s) inspection, visualization, marking, cleaning, and/or repair. Example and non-limiting inspection surfaces include, without limitation, surfaces such as: a tank wall; a pipe wall; a surface associated with any industrial process or equipment; a cooling tower; a pressure vessel; a tray or interior feature; and/or a heat transfer tube, wall, pipe, or the like. In certain embodiments, an inspection surface may include a metallic surface and/or a ferrous surface. Example inspected surfaces may include any exterior or interior surface, an elevated surface (e.g., a surface including at least a portion that is at a relevant height for fall protection considerations), and/or a confined space (e.g., a surface including at least a portion that would be considered a confined space).

In certain embodiments, an operation may be understood to be an inspection operation for one purpose, but another type of operation for another purpose (e.g., a visualization operation of the surface may be understood to be an inspection operation, but may additionally or alternatively be a preparatory operation, a confirmation operation, etc., which may depend upon the entity describing the operation, whether any anomalies and/or features are detected during the operation, etc.). The specific terminology utilized for an operation is not limiting to the present disclosure, and “inspection operations” or similar terminology utilized herein should be understood to include any service operations, performable by inspection robots set forth herein, at a service location.

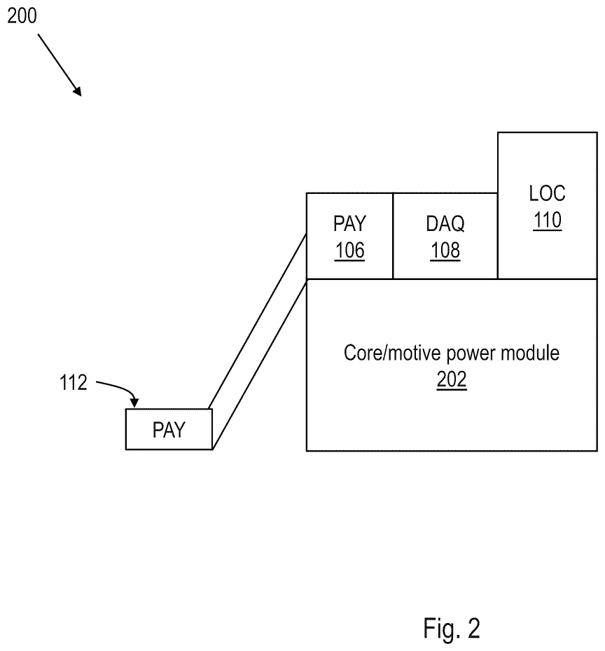

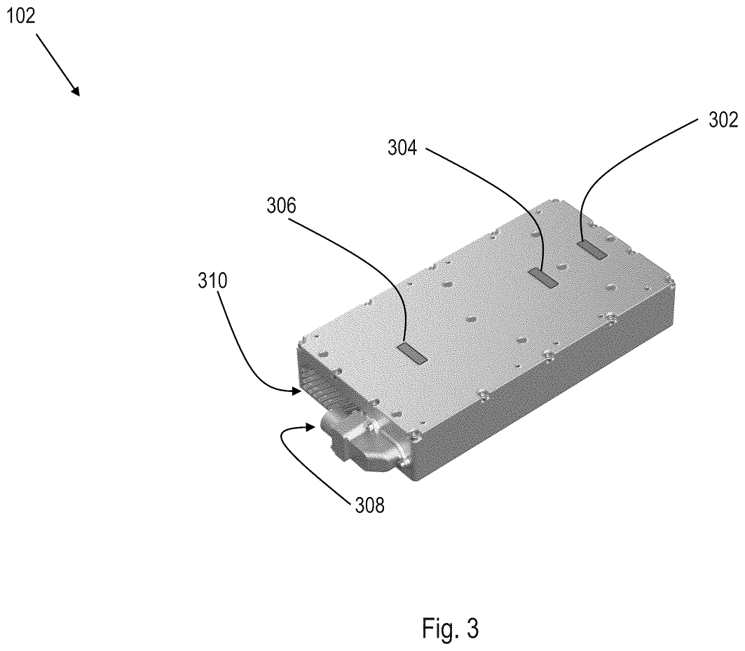

Referencing FIG. 3, an example core module 102 capable to interface with a number of supporting modules which, when coupled with the core module, provide a completed inspection robot having the selected capability to perform inspection operations. The example core module 102 provides power for operations of the inspection robot, which may include providing power through a tether (e.g., coupled at tether connection 308) to a base station (e.g., a supporting station coupled to the inspection robot 102 with the tether, and providing power, couplant, and/or communications with the inspection robot), but which may additionally or alternatively include a battery having sufficient energy storage to support a typical inspection operation, and/or to support a selected range of inspection operations (e.g., considering power consumption during operations, the duration of operations, any margin to support uncertainty of inspection operations (e.g., uncertainty of duration and/or power consumption), and/or any power reserve (e.g., preserving sufficient power to return to a base location from any position on the inspection surface). In a non-limiting example, the core module includes a 600 W power supply tethered to a base station, which supports a wide variety of commercially valuable operations for a number of sensor and/or other component configurations. In certain embodiments, the core module 102 mounts on an inspection robot base, which includes the substrate of the inspection robot to provide structural support for the other components of the inspection robot. In certain embodiments, the core module 102 may be considered as a part of the inspection robot base, and/or the inspection robot base may be considered as a part of the core module 102. An example embodiment includes the core module 102 mounted to, and/or formed integrally with, the motive power module 104 (e.g., reference FIG. 2, combined core/motive power module 202). In certain embodiments, the portion of the inspection robot that does not typically change between inspection operations, and/or that is utilized to uniquely identify the base robot version, includes the core module 102, and/or the combined core/motive power module 202.

In certain embodiments, the core module 102 is swappable to support different capabilities for other modules (e.g., distinct localization modules, DAQ modules, or the like), to support different power ratings for the inspection robot, or the like. In certain embodiments, the core module 102 is universal, for example where the core module is not changed out separately from the inspection robot base. The utilization of a core module 102 allows for other modules to be changed with limited interface adjustments, for example by engaging or disengaging a single connector and/or a limited number of physical support connectors (e.g., screws, bolts, mounting points, quick connectors, etc.), without exposing interior aspects of either the core module (e.g., wires, printed circuit boards, memory chips, power converters, etc.) or the engaged modules (e.g., localization, DAQ, and/or peripheral) to potential contamination, reducing the complexity of configuration, and limiting exposure of the modules to environmental intrusion and/or physical damage. An example core module supports communication busses (e.g., ethernet, CAN, and/or I2C), support for a selected number of actuators (e.g., four actuators to support drive modules), and coupling to the base station.

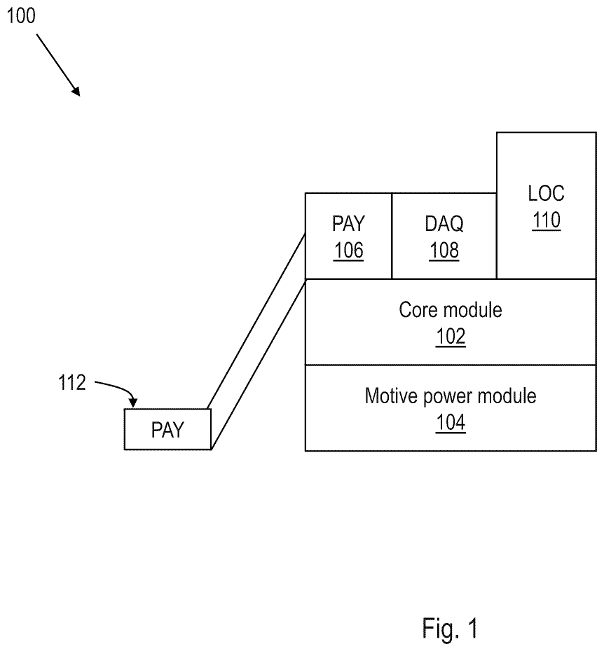

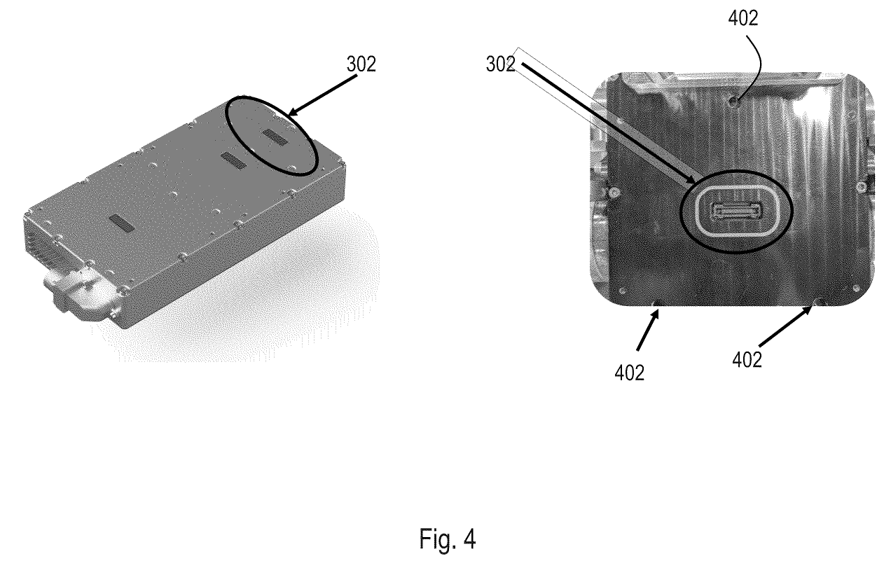

The example core module 102 includes interfaces for mounting three supporting modules thereon, including a payload (or peripheral) module 106 coupled to a peripheral module interface, a DAQ module 108 coupled to a DAQ module interface, and a localization module 110 coupled to a localization module interface. In the example of FIG. 1, the three supporting modules include a localization module, a data acquisition module, and a peripheral module. The example modules support a large range of available capabilities for the inspection robot, and are configured to simplify changing out a minimum number of components, with logical breakpoints for selected capability groups, to support high configurability as set forth herein. The example core module includes the core module interface 302, configured to couple the core module to a peripheral module 106, in the example of FIG. 4. In certain embodiments, coolant is passed to the payload through the peripheral module interface, and/or with a parallel couplant cabling that passes couplant from the tether to the payload 112. In certain embodiments, the payload 112 may not utilize couplant. In certain embodiments, engaging the peripheral module interface ensures the correct electrical, power, and communication coupling for the peripheral module. In certain embodiments, a couplant to the payload 112 may be provided through the peripheral module interface, and/or as a separate parallel connection.

In certain embodiments, the physical coupling interface for one or more of the supporting modules, or all of the supporting modules, are keyed 402 to ensure that the supporting module is installed properly (e.g., reference FIG. 4). In certain embodiments, supporting modules that are likely to be swapped at the service location, or at a location with minimal facilities, are keyed. In certain embodiments, each of the supporting modules are keyed (e.g., the peripheral module interface 302, in the example of FIG. 4). The key 402 may include detents and pegs between the core module 102 and the other modules 106, 108, 110, for example to ensure that each module type can be mounted only in the appropriate mounting location, and/or that the installed module will be correctly oriented. In certain embodiments, for example with pegs and/or detents that can be actively controlled by a computing device, and/or at a time of manufacture (e.g., where providing dedicated keying for a particular core module is feasible), the pegs and/or detents may be arranged such that only a specific version of the support module (e.g., version 2.6 of the peripheral module may include a first keying arrangement, and version 3.1 of the peripheral module may include a second distinct keying arrangement).

An example localization module 110 mounted at the location module interface 306 includes components that support localization operations of the inspection robot, which may be selected according to the localization requirements of the inspection operations, and/or according to the supporting infrastructure available at the service location. For example, the localization module may include one or more sub-components such as a laser rangefinder, a prism based locator (e.g., a prism on the localization module, and/or a that determines the position of the inspection robot with one or more positioned prisms at the service location), an accelerometer, a gyroscope, a GPS locator device, another locator device (e.g., utilizing WiFi location), or the like. In certain embodiments, localization operations of the inspection robot may be performed utilizing other components of the inspection robot apart from the localization module 110—for example utilizing a camera associated with the peripheral module 106 and/or utilizing an encoder associated with a drive module 108 and/or a payload 112 of the inspection robot. Certain considerations for determining which components are to be included on a localization module, if present, include the availability of supporting localization infrastructure at the service location (e.g., the availability of located WiFi devices, GPS availability, appropriate locations for positioning of prism(s) and/or rangefinders, and/or the availability of features that can be located and/or evaluated with a camera). Accordingly, the inclusion of a modular localizing component (e.g., the location module) supports rapid reconfiguration of an inspection robot to perform localization operations for a variety of service locations. In certain embodiments, the localization module 110 includes a line-of-sight location device, such as a rangefinder, RTS (robot total station) prism, LiDAR, WiFi localization, or the like, where a prominent position toward the rear and/or top of the inspection robot is advantageous for the localization module to improve the available operating space for the localization module 110.

The example DAQ module 108 includes data acquisition, processing, and/or communication components to support a selected payload of the inspection robot. For example, distinct sensor suites (e.g., ultra-sonic (UT) sensors, electro-magnetic (EM) sensors, temperature sensors, magnetic flux leakage, visual inspection payloads, profilometers, sonic sensors, etc.) utilize significantly distinct data rates, types of data, supporting data processing, command traffic (e.g., command of sensing operations, fault code traffic, diagnostic traffic, etc.), supported network types (e.g., ethernet, CAN, I2C, etc.), or the like, where utilization of a distinct DAQ module for different sensor suites to allow for quick changes of capability without requiring a software change, communication protocol, I/O changes, or the like that would otherwise be required, for example, to utilize a single generalized DAQ component to provide similar range of capabilities. The various versions of a DAQ module utilize a same interface to the core module to support the full range of DAQ capabilities for the various sensor suites supported by the inspection robot.

The example peripheral module 106 includes interfaces to a payload 112 for the inspection robot, for example to operate associated actuators with the payload (e.g., an actuator to perform rastering operations, to provide selected downforce to the payload 112, to operate a sprayer for marking and/or cleaning, to operate a repair actuator such as a welder, adhesive dispenser, a laser ablation device, surface preparation device, an induction coating removal device, a couplant flow control valve and/or pump, etc.). The example peripheral module 106 further includes selected supporting components for the inspection robot—for example a camera—and/or includes interfaces to such components (e.g., where a camera is provided on the payload). The utilization of a peripheral module 106 allows for flexible support for a number of components, dividing the responsibility between the relatively consistent operations performed to support sensing (e.g., via the DAQ module), localization operations (e.g., via the localization module 110), and flexible operations for peripheral components (e.g., via the peripheral module 106). The division of responsibilities between the localization module 110, DAQ module 108, and/or the peripheral module 106 is a non-limiting example, and provides for a logical grouping of responsibilities that are capable to support a wide range of commercial applications. Certain aspects of the inspection robot, for example interfaces with the payload, may interface with multiple ones of the supporting modules. For example, sensor data and control for sensors of the payload are provided through the DAQ module 108, and payload actuator control of the payload is provided through the peripheral module, in the depicted example. Stated differently, the organization of modules in the depicted example is a functional organization. In certain embodiments, a different organization of modules may be provided, for example one supporting module may interact with the payload, including sensing and actuating. Additionally or alternatively, a component on one supporting module may support operations generally associated with another supporting module—for example a camera associated with a peripheral module may be considered as an inspection sensor for certain inspection robots and/or inspection operations (and/or another camera associated with the DAQ module 108 may be present for certain embodiments).

The example embodiment of FIG. 1 further includes a motive power module 104 having a motive power device (e.g., an electric motor, and/or an electric motor powering a hydraulic and/or pneumatic actuator), and at least one magnetic engagement device (e.g., a magnetic wheel and/or magnetic track configured to provide sufficient coupling force to keep the inspection robot on the inspection surface). In certain embodiments, the motive power modules 104 are directly coupled to interfaces on the core module 102. In certain embodiments, the core module 102 includes a drive module interface 310 that couples the core module 102 the motive power module(s) 104 for electrical power and/or communications. In certain embodiments, the motive power module 104 may be controlled by a computing device on another module, for example the core module 102 and/or the peripheral module 106. The example motive power modules 104 are depicted as magnetic hub-based wheels, but any type of drive module and/or motive movement and/or control may be utilized.

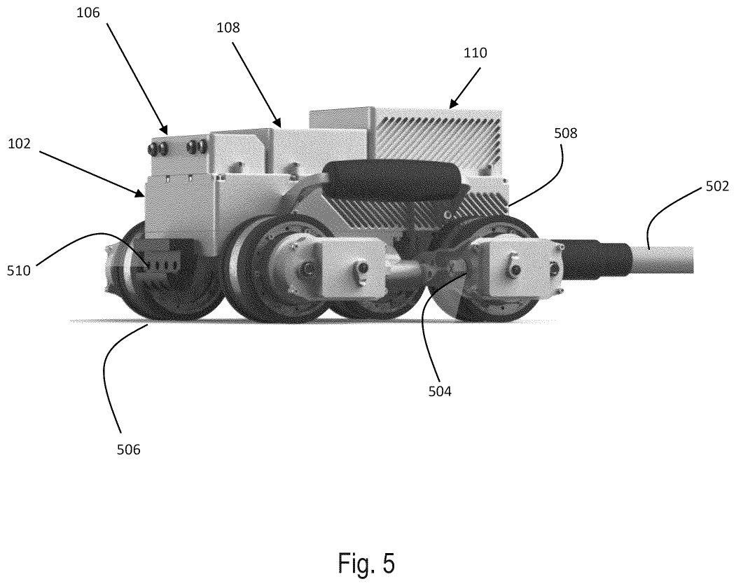

Referencing FIG. 5, an example assembled inspection robot is schematically depicted, with a localization module 110, DAQ module 108, and peripheral module 106 mounted on a core module 102. The example of FIG. 5 depicts an example payload mounting location 510 for the payload—for example with a mounting location at the front of the inspection robot. It can be seen that the inspection robot supports any type of payload that can be mounted on the inspection robot 102, with control and data operations for the payload provided by the supporting modules as set forth herein. The example of FIG. 5 further includes a tether 502 providing electrical, communication, and/or couplant to be exchanged with and/or provided by a base station (not shown). The example of FIG. 5 depicts cooling fins 508 on a number of housing elements and modules, including for example a housing that defines the core module. The utilization of cooling fins expands the operating range of the inspection robot, allowing for inspections to be performed on a wider variety of surfaces, and/or to perform operations without utilizing the couplant as a coolant (e.g., to cool motive power devices within the motive power module). In the example of FIG. 5, the motive power module includes a motive power drive 504 (e.g., and electric motor) and a magnetic engagement device 506 (e.g., a magnetic wheel in the example).

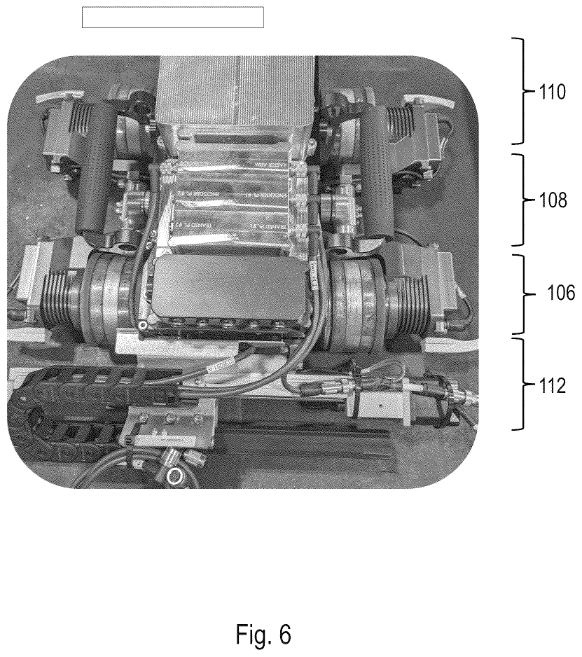

Referencing FIG. 6, an example inspection robot includes a number of modules installed thereon, with the example of FIG. 6 depicting, from front to back: a payload 112 mounted to the front of the inspection robot, a peripheral module 106 mounted at a forward position on top of the inspection robot, a DAQ module 108 mounted at a mid position on top of the inspection robot, and a localization module 110 mounted at a rear position on top of the inspection robot.

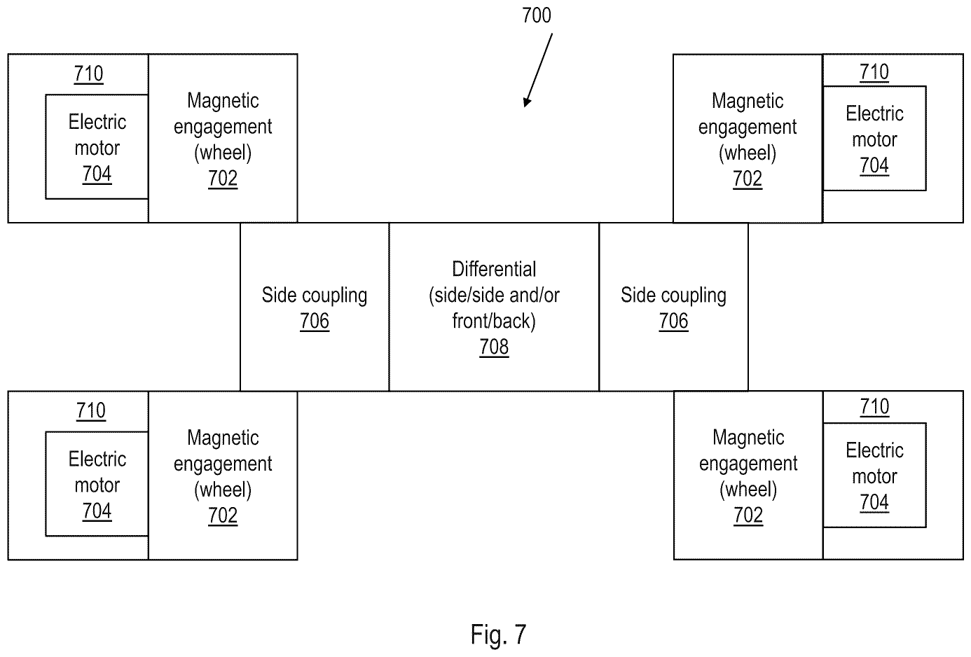

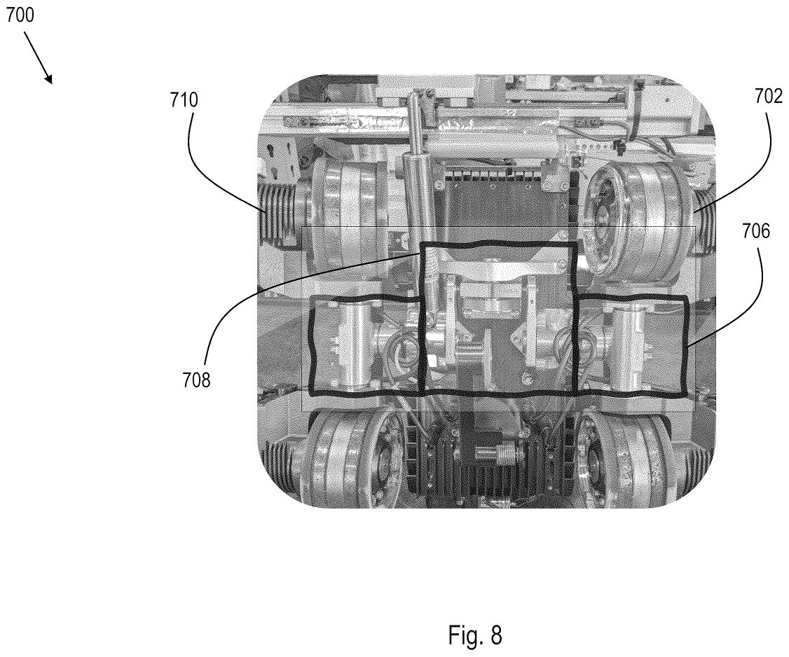

Referencing FIG. 7, an example motive power module is schematically depicted, consistent with the example robot 700 of FIGS. 8-13. The example motive power module includes the differential 708 that enforces the selected rotational transforms between the drive modules on each side. Each drive module includes a side coupling component 706 that enforces one degree of axial alignment between the wheels on that side (e.g., magnetic wheel at the top on one side with the magnetic wheel at the bottom on the same side), and magnetic wheels 702 that engage the inspection surface and hold the inspection robot. The example motive power module includes an electric motor 704 (e.g., one motor per wheel, in the example, although one or more wheels may not be powered) within a housing 710, wherein the housing 710 includes shaped cooling fins to promote passive cooling for the associated motor 704 whether the inspection robot is in a horizontal position or a vertical position.

Referencing FIG. 8, an example suspension system for drive modules (or motive power modules) herein is schematically depicted in an underside view of the inspection robot 700. The example suspension system provides for coordinated movement of the individual elements of the motive power module (and/or for each motive power module, depending upon whether each wheel and/or motor is considered as an element of the motive power module, or as a separate motive power module). In the example embodiments, the motive power module(s) are mounted physically to the inspection robot base, and interfaces with and is controlled by the core module 102 (and/or a combined core/motive power module 202, and/or a peripheral module 106). The example suspension system includes a differential component 708 that enforces a rotational transformation between the two drive modules on each side, where the rotational transform includes any rotational relationship enforced between the two drive modules. For example, and example differential component 708 enforces a counter droop, where if the wheels drop on one side, the differential component 708 urges the wheels on the other side to droop the same amount. In another example, the example differential component 708 enforces a same engagement tilt (e.g., the wheels on one side rise to get over an obstacle, and the front wheel on the other side raises a same amount, or a proportional amount), and/or enforces a reverse engagement tilt (e.g., causing the wheels from the two sides to counter rotate, or ice cube tray, which may assist in traversing certain types of obstacles), for the wheels on each side for the respective drive module(s).

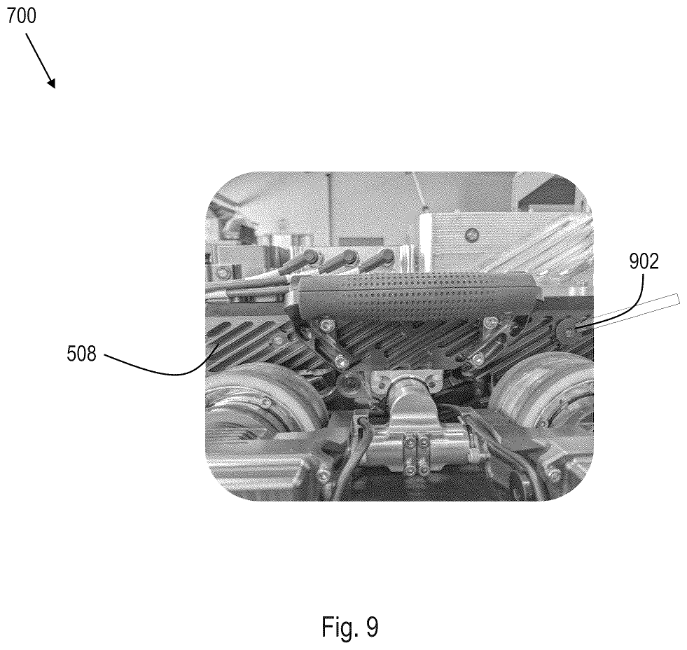

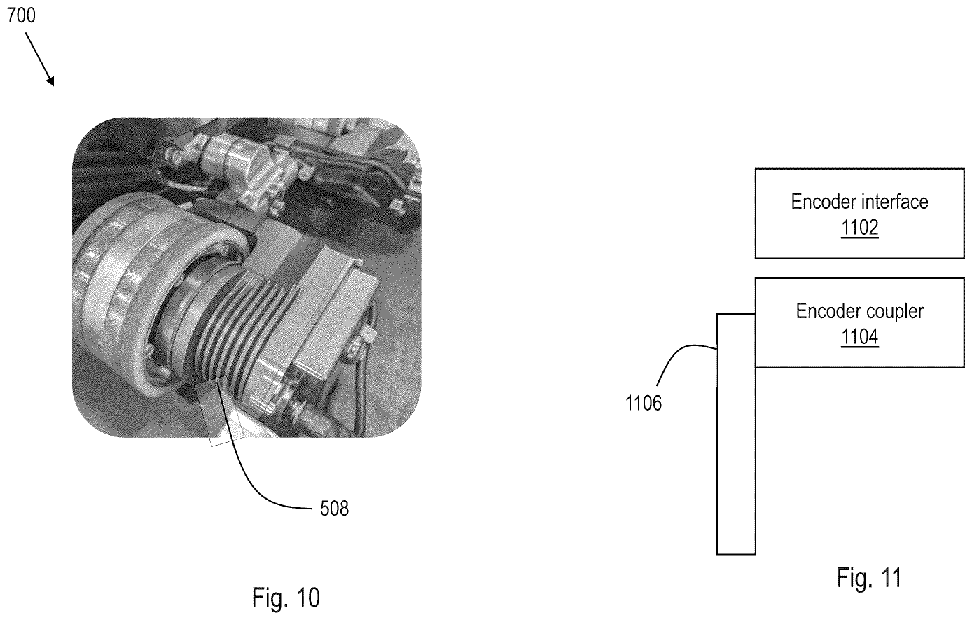

Referencing FIG. 9, the example core module includes diagonal cooling fins 508 on the core module housing, and a leak port 902 that provides a coupling to the core module housing. Referencing FIG. 10, another view of the inspection robot 700 includes the example drive module having cooling fins 508 on a housing defining a motive power device (e.g., an electric motor that drives the wheel). The combination of cooling fins on the core module housing and the motive power device housing allow for a wide range of applications to be supported without resort to liquid cooling of the main boards or power electronics in the core module, and/or of the motive power devices.

In certain embodiments, for example where a payload includes UT sensors having a couplant provided to the inspection robot for supporting operations of the UT sensors to acoustically couple to the inspection surface, it may be desirable to utilize the couplant for cooling of the drive modules and/or heat generating components within the other modules (e.g., PCBs, power converters, etc. within the core module, DAQ module, localization module, and/or peripheral module). In certain embodiments, performing cooling without utilizing available couplant supports the modularity, flexibility, and/or configurability of the inspection robot—for example providing an inspection robot where sufficient cooling is performed passively, where the inspection robot performs for payloads either with or without available couplant. In certain embodiments, for example where couplant or any other fluids (e.g., cleaning, surface preparation, and/or repair fluids) are provided to the inspection robot, such fluids are provided directly to the utilizing component (e.g., the payload of the inspection robot), and are not used secondarily for module support. In certain embodiments, supporting operations for managing such fluids may be nevertheless performed by one or more modules, for example with a flow control valve or pump operated by the peripheral module.

The example inspection robot of FIG. 9 further includes a dual purpose port 902, provided on the core module 102 in the example, that allows for leak testing and provides a place to engage a desiccant that is operationally coupled to the core module (e.g., to protect components, such as PCBs and/or power converters, from humidity or the like). In certain embodiments, leak testing and/or desiccant holding functions may be performed utilizing separate ports, and/or omitted. In the example of FIG. 9, the core module is further depicted with cooling fins 508, for example to support passive cooling of the core module. The example cooling fins 508, 708, for both the drive module(s) and the core module, are geometrically positioned to support passive cooling on either a horizontal or vertical inspection surface, further supporting flexible capability for the inspection robot. In certain embodiments, any motors, actuators, or other heat generating components of the inspection robot are configured to perform with passive cooling, including thermally coupling heat generating components with heat rejection components, providing cooling fins associated with supporting modules, payloads, or the like.

Referencing FIG. 11, an example encoder for an inspection robot is schematically depicted. The example encoder includes an encoder component 1106 that engages the inspection surface during motive operations of the inspection robot, tracking the amount of movement of the inspection robot. In certain embodiments, the central position of the encoder component 1106 reduces corrections that must be made for location determination during turns of the inspection robot, or other non-linear progression on the inspection surface. The example encoder includes an encoder coupling 1104, coupled to the encoder component 1106, and/or integrally formed with the encoder component 1106, and an encoder interface 1102 on the core module (e.g., providing power and/or communications to the encoder, allowing controls on the inspection robot, base station, and/or cloud server, to utilize the encoder information for localization and/or other data analysis operations).

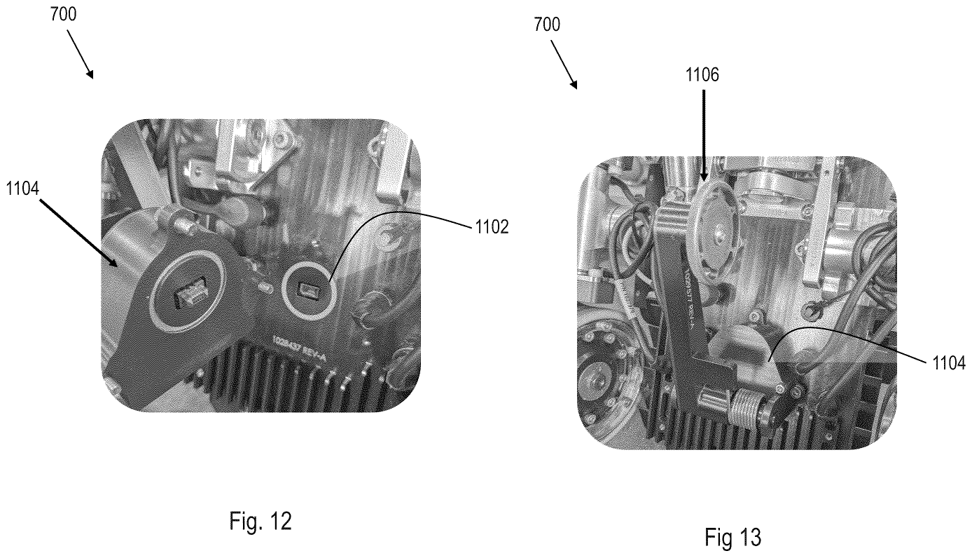

Referencing FIG. 12, an example encoder couples to the inspection robot base and/or core module, including physical mounting and/or electro-mechanical mounting. The example encoder includes the encoder coupling 1104 configured to plug into the encoder mount 1102 on the core module 102, thereby completing the coupling of the encoder component. Referencing FIG. 13, the encoder component 1106 extends below the inspection robot, in a position to engage the inspection surface when the inspection robot is placed on the inspection surface.

The example encoder supports position determination of the inspection robot, and/or is utilized in control of the drive modules. In certain embodiments, the encoder includes serrations that are configured to support operations of the encoder without slipping, and without marking or scratching the inspection surface, for example if side-to-side movement of the encoder occurs while engaged with the inspection surface. The example inspection robot further includes a tether coupling that is configurable, for example by swapping out the core module. In certain embodiments, the tether connection is split, for example with fluids bypassing the core module and passing directly to the utilizing component, for example to the payload. In certain embodiments, the tether includes power, communication, and/or electrical connections directly coupled to the core module, where a single tether supports a wide range of applications and does not need to be configured for the particular application.

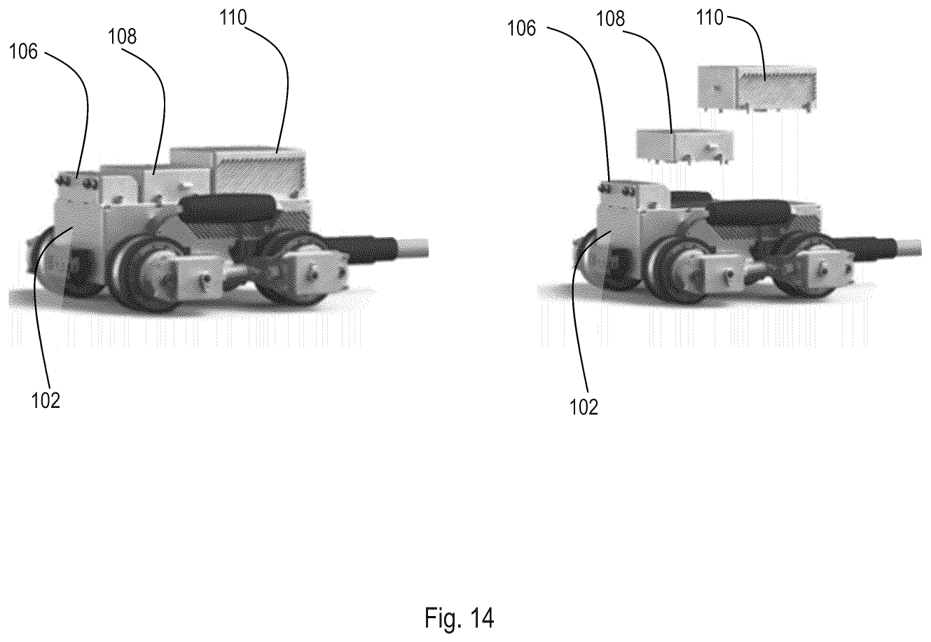

Referencing FIG. 14, an example inspection robot is depicted with supporting modules 106, 108, 110 in an engaged position (left portion of the figure) with the core module 102, and in an exploded view in a disengage position (right portion of the figure), which may be operations performed to reconfigure the inspection robot to change capabilities, to prepare for specific operations, or the like. In the example of FIG. 14, the locational module 110 and DAQ 108 module are depicted as disengaged in the example, as a non-limiting example. For example, a peripheral module 106 may not be changed during a given re-configuration operation. In another example, the depiction of FIG. 14 may be depicted at an intermediate stage of a re-configuration operation, where the peripheral module 106 has already been swapped, or will be swapped at a later time.

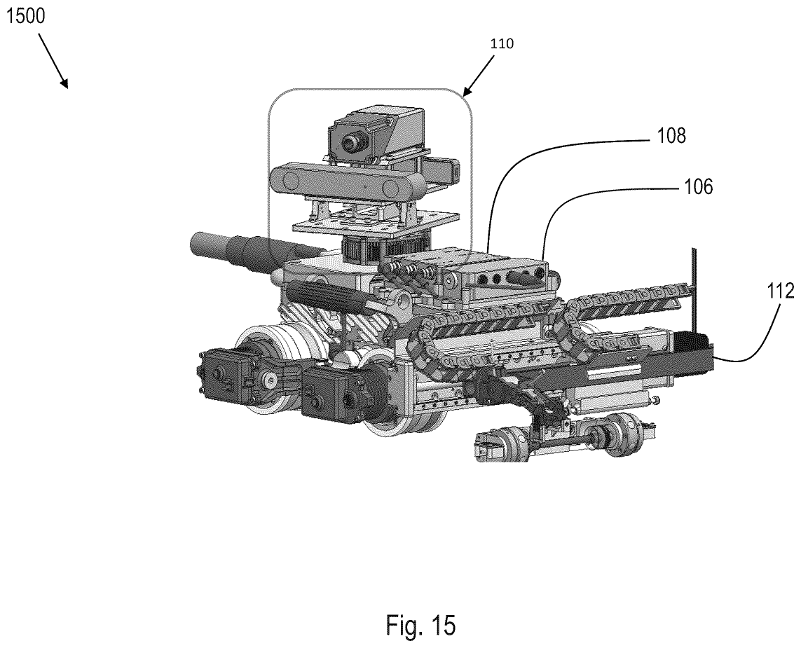

Referencing FIG. 15, an example inspection robot 1500 is depicted with supporting modules 106, 108, 110. The example inspection robot 1500 includes a rastering payload 112, a localization module 110 with a locating prism mounted thereon, a DAQ module 108, and a peripheral module 106. The example localization module 110 includes a range finder mounted on a rotatable actuator.

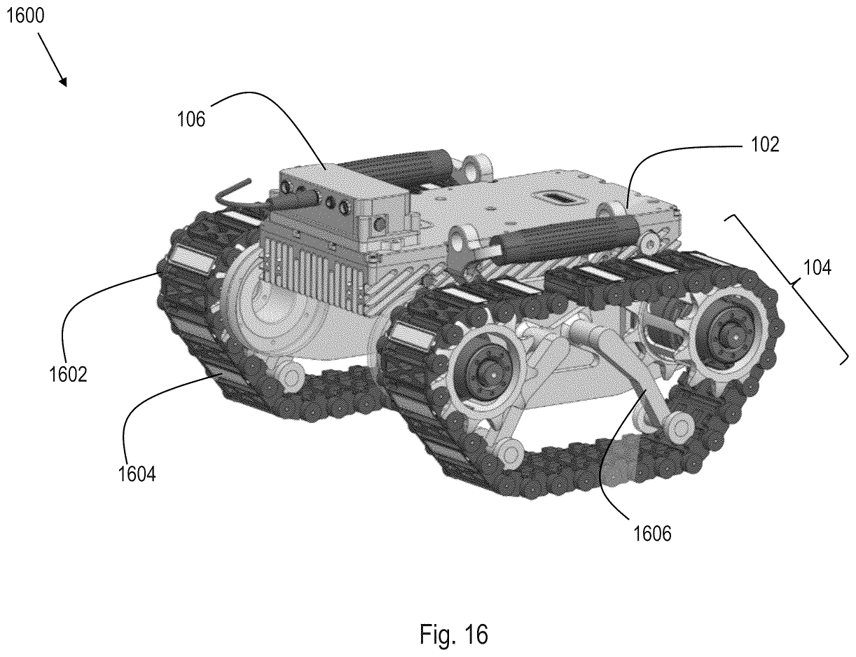

Referencing FIG. 16, another example inspection robot 1600 is depicted. The example inspection robot is either at an intermediate configuration stage (e.g., before the DAQ module 108 and/or localization module 110 are engaged), and/or in a configuration where a DAQ module 108 and/or a localization module 110 are not needed for the planned inspection operations. The example inspection robot 1600 includes an alternate assembly for the drive module (and/or motive power module), with a tracked drive module 104 depicted in the example. The example drive module may include magnetic elements, for example magnetic pegs 1604 provided within the track assembly. The example inspection robot 1600 includes the track contact portions 1602 of the drive module 104 that engage the inspection surface. In the example of FIG. 16, an actuator 1606 adjusts a form factor of a trapezoidal shape of the drive module 104, allowing for control of the ramp height, ramp angle, short leg length, long leg length, and/or control of the ramp parameters differentially between a leading ramp (e.g., the forward ramp of the trapezoid where the inspection robot is moving forward) and a trailing ramp. An example actuator 1606 adjusts a diagonal characteristic ratio of the trapezoidal shape of the drive module 104, for example adjusting a ratio of either diagonal of the trapezoid to any side of the trapezoid, including for example the short leg side, the long leg side, the leading ramp side, and/or the trailing ramp side. The example tracked drive module 104 of FIG. 16 provides for a flexible configuration to traverse a number of surfaces, and provides for a large number of applications to be supported using a consistent core module/drive module pairing, greatly improving the efficiency designing and implementing inspection robot configurations for different applications.

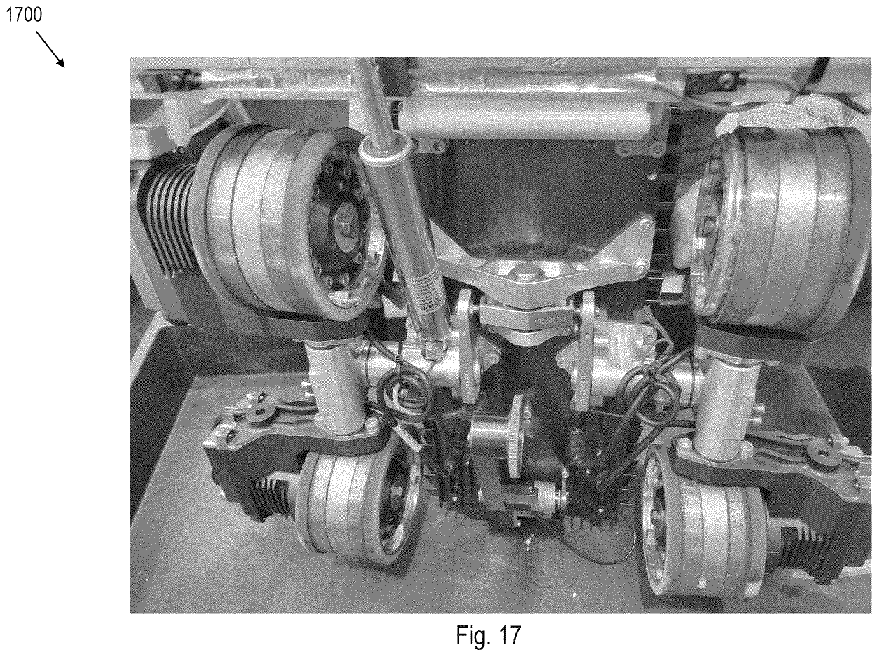

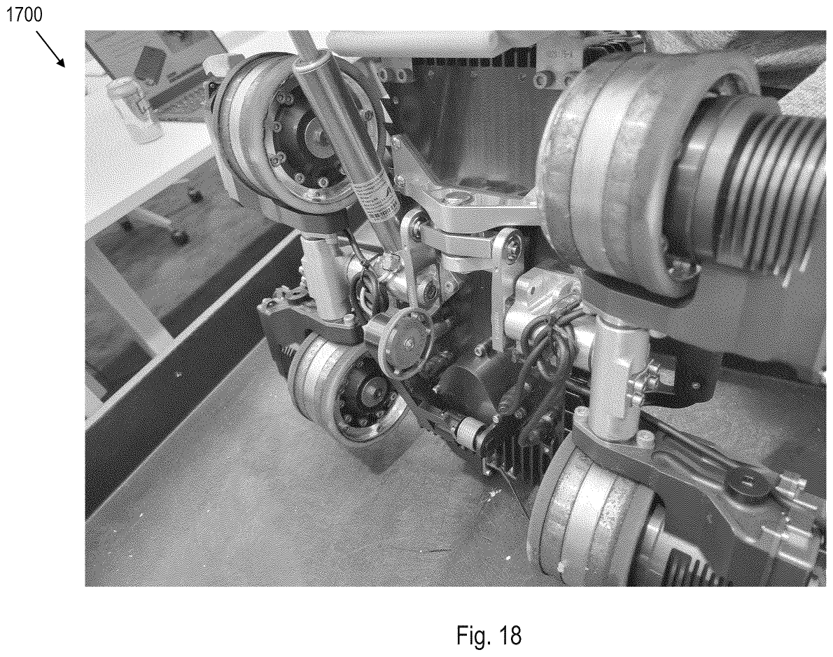

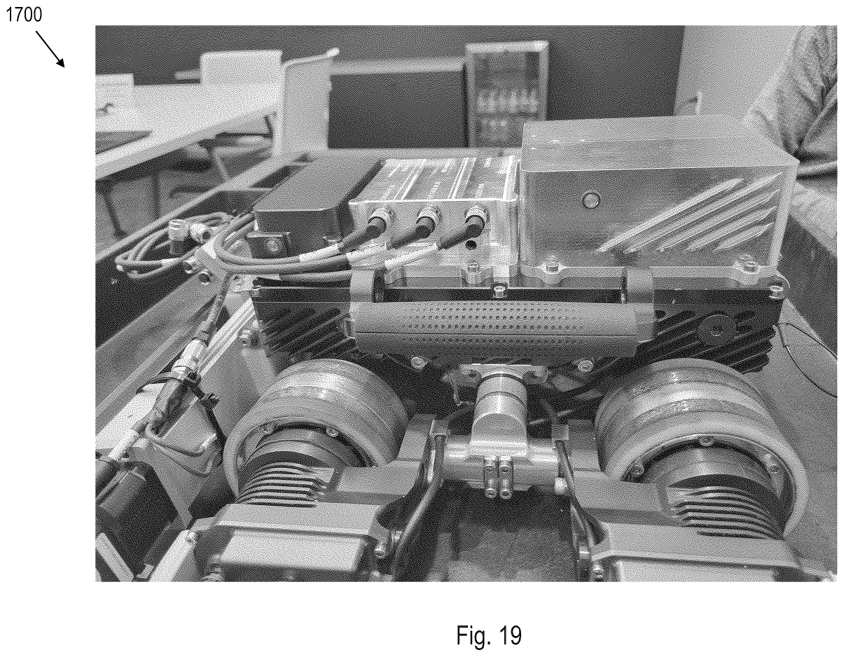

Referencing FIGS. 17-18, example views of an underside of an example inspection robot 1700, including an encoder and drive modules, are depicted. The examples of FIGS. 17-18 provide additional views for an encoder arrangement and differential component for the drive module. Referencing FIG. 19, an example side view of an example inspection robot is schematically depicted. In the example side view, example arrangements for the drive modules, cooling fins on the drive modules, cooling fins on the core module, an arrangement for coupling of the peripheral module, DAQ module, and localization module, can be seen. The example of FIG. 19 provides an example and non-limiting packaging arrangement applicable to certain embodiments.

An example inspection robot 100, 200, 700 includes a motive power module 104 including a motive power device, including: a motive power module including a motive power device (e.g., an electric motor 704) and a magnetic engagement device (e.g., a wheel and/or track), coupled to a core module 102 including a tether connection 308, a peripheral module interface 302, a power management component (e.g., internal power electronics and/or switching capable to provide selected power to the motive power module 104, the peripheral module 106, the DAQ module 108, and/or the localization module 110), and a data acquisition (DAQ) module interface 108. The example inspection robot 100, 200, 700 includes a peripheral module 106 coupled to the peripheral module interface 302, the peripheral module 106 including power coupling and communications coupling for a selected payload 112—for example where the core module 102 supports sufficient power, communications, I/O capability, etc., at the peripheral module interface 302 to support the planned configuration of sensors for the payload 112. The example inspection robot 100, 200, 700 includes a DAQ module 110 coupled to the DAQ module interface 304, where the DAQ module includes a data acquisition circuit (e.g., embodied as computer readable code stored on a medium that, when executed by a processor performs one or more operations of the data acquisition circuit, and/or embodied as any sensor, actuator, display device, logic circuit, or the like as configured to perform one or more operations of the data acquisition circuit) that collects, stores, and/or transmits data from the selected payload to an external device (e.g., a base station, laptop, or other computing device of an operator on-site, and/or up to a cloud server for further analysis and/or long term storage).

An example core module 102 is configured to communicatively couple the payload 112 with the data acquisition circuit, for example by providing direct electrical coupling, and/or operating as a switch for data communications to the DAQ. An example core module 102 includes a network communication circuit that performs at least a portion of the transmitting data to the external device, for example where the network communication circuit passes data through the tether to a base station and/or operator computing device, and/or where the DAQ module 110 includes a direct communication to the cloud, for example using cellular services, where the direct communication may be intermittently available, and/or expensive to use, and accordingly the network communications circuit of the core module 102 may manage some or all of the data communications to external devices.

An example magnetic engagement device includes a number of magnetic wheels, where at least one of the magnetic wheels is operatively coupled to an electric motor to provide motive power. In certain embodiments, the electric motor may indirectly power the wheels, for example where the electric motor is utilized to charge a hydraulic and/or pneumatic system that provides direct motive power.

An example motive power module includes a chassis for the inspection robot, where the core module 102 is mounted on the chassis (e.g., reference FIGS. 2, 7, and 16). In certain embodiments, the core module 102 comprises a base robot configuration, for example where referencing a version number of the core module 102 identifies a version number of the inspection robot 100, 200, 700. In certain embodiments, the core module 102 coupled to the motive power module comprises a base robot configuration, for example where referencing the version numbers of the core module 102 and motive power module 104 identifies a version number of the inspection robot 100, 200, 700.

An example inspection robot includes a payload having a camera. An example payload includes an electromagnetic sensor. In certain embodiments, the data configuration and requirements for various sensors may vary considerably with each sensor type, for example the visual data of a high resolution camera may have different formatting, network priority, sensitivity to noise or disruption, etc., than high rate inspection data for a UT inspection. Thus, various embodiments of the peripheral module 106 may be utilized to support the various sensor packages, with the peripheral module interface having sufficient support to allow coupling to the superset of the supported payloads, sensor packages, or the like that are supported by the peripheral module.

An example peripheral module interface includes a couplant interface, where the couplant connection between the tether and the peripheral module is provided on the peripheral module interface, and/or in a parallel connection to any electromechanical coupling of the peripheral module with the core module.

An example core module 102 includes the peripheral module interface 302 and the DAQ module interface 304 on a topside of the core module 102. In certain embodiments, the peripheral module interface 302 is positioned forward relative to the DAQ module interface 304. An example peripheral module interface 302 includes a keying assembly 402 that ensures that only a peripheral module 106 can be mounted on the peripheral module interface 302. In certain embodiments, the keying assembly 402 may ensure that only a correct version of the peripheral module 106 may be installed, and/or ensures that the peripheral module 106 is installed only in a correct orientation.

An example DAQ module interface 304 includes a keying assembly 402 that ensures that only a DAQ module 108 can be mounted on the DAQ module interface 304. In certain embodiments, the keying assembly 402 may ensure that only a correct version of the DAQ module 108 may be installed, and/or ensures that the DAQ module 108 is installed only in a correct orientation.

An example core module 102 further includes a localization module interface 306. In certain embodiments, the peripheral module interface 302 is on a top side of the core module 102 in a forward position, the localization module interface 306 is on a top side of the core module 102 in a rearward position, and the DAQ module interface 304 is on a top side of the core module 102 at a position between the peripheral module interface 302 and the localization module interface 306. An example localization module interface 306 includes a keying assembly 402 that ensures that only a localization module 110 can be mounted on the localization module interface 306. In certain embodiments, the keying assembly 402 may ensure that only a correct version of the localization module 110 may be installed, and/or ensures that the localization module 110 is installed only in a correct direction. In certain embodiments, the rearward positioning of the localization module interface 306 facilitates placing a supported aspect of the localization module 110 at a most rearward position, allowing the supported aspect to have a better chance at maintaining line-of-sight contact with devices, identified features, the base station, reference points, etc. An example localization module 110 includes a line of sight localization component, such as: a robotic total station prism, a LiDAR component, a WiFi ranging component, and/or a camera.

An example inspection robot 100, 200, 700 includes a motive power module 104 having a motive power device, a magnetic engagement device, and a housing defining the motive power device, where the housing including cooling fins. The example inspection robot 100, 200, 700 includes a core module 102 coupled to the motive power module, the core module 102 including a tether connection 308, a peripheral module interface 302, a power management component (not shown), and a data acquisition (DAQ) module interface 304. The example core module 102 provides power to the motive power device, potentially utilizing a drive module interface 310.

An example inspection robot includes the peripheral module interface 302 having a power coupling, a communications coupling, and/or a couplant coupling, and a payload module 106 including an ultrasonic sensor on a payload, coupled to the peripheral module interface. In certain embodiments, the core module 102 and/or the motive power modules 104 are configured to support operation of the motive power device without utilizing liquid couplant passing through the inspection robot, from the tether to the payload, as a coolant in the system. In certain embodiments, cooling fins on the core module 102 and/or the motive power modules 104 in thermal contact with the motive power devices provides sufficient cooling for operation of the motive power devices. In certain embodiments, a thermoelectric cooler is utilized to boost or maintain heat transfer rates between the heat generating component (e.g., power electronics for the core module 102, computing devices for the core module 102 and/or DAQ module 108, an electric motor of the motive power module 104, and/or a printed circuit board (PCB) positioned in any module), for example interposed between a heat generating component and a final heat rejection surface (e.g., a housing wall, bank of cooling fins, etc.).

An example core module 102 includes a housing defining the components of the core module 102, where the interfaces 302, 304, 306, 308, 310 provide defined access through the housing. An example core module 102 includes a leak test port 902 providing access to the housing (e.g., reference FIG. 9), for example to seal the housing and perform a pressure leak test. In certain embodiments, the leak test port 902 is a dual use port, utilized as a leak test access point during leak test operations, and providing a dessicant cartridge access point during operation and/or storage operating conditions.

An example motive power device includes a tracked motive power device (e.g., reference FIG. 16). The example tracked motive power device includes a trapezoidal form factor, for example with a longer top side and shorter bottom side, allowing the tracks to form a ramp during motive operations to allow the inspection robot to traverse obstacles. An example inspection robot 100, 200, 700 includes a ride adjusting actuator 1606 that allows the motive power module 104 to respond to commands to adjust the form factor of the tracked motive power device, for example to adjust a height and/or angle of the ramp, including providing for asymmetrical ramp shapes in certain embodiments (e.g., a leading ramp is taller, steeper, shallower, etc., relative to the trailing ramp).

An example inspection robot 100, 200, 700 includes a motive power module having a first drive module on a first side, the first drive module including the motive power device and the magnetic engagement device; a second drive module on a second side, the second drive module including a second magnetic engagement device; and a differential 708 coupling the first drive module to the second drive module, where the differential 708 is positioned below the housing. The differential 708 enforces one or more rotational transformations between wheels of the first and second drive module, for example ensuring that they rotate together, or in opposite directions, for a droop rotation and/or a tilt type rotation of the wheels of the drive modules (and/or for opposing tracks of the drive modules in certain embodiments). An example inspection robot 100, 200, 700 further includes an encoder 1106 coupled to the bottom of the housing, and configured to engage the inspection surface, thereby tracking the inspection robot's movements in response to encoder rotations and position. An example encoder 1106 is mounted to a gas spring, providing a biasing force toward the surface that is easily overcome if encountering an obstacle or the like, allowing the encoder to lift without being damaged.

An example inspection robot 100, 200, 700 includes a motive power module 104 having a motive power device and a magnetic engagement device, a core module 102 coupled to the motive power module 104, the core module 102 including a peripheral module interface 302, a data acquisition (DAQ) module interface 304, and wherein the peripheral module interface 302 includes a keying assembly configured to ensure that only a peripheral module can be mounted on the peripheral module interface. Any one or more of the interfaces 302, 304, 306 may be keyed, and the interfaces 302, 304, 306 may be positioned on any surface of the core module 102, at any desired location.

An example inspection robot 100, 200, 700 includes a motive power module 104 including a motive power device and a magnetic engagement device, coupled to a core module including a tether connection, a peripheral module interface, a power management component, a data acquisition (DAQ) module interface, and/or a localization module interface. The inspection robot 100, 200, 700 further includes a localization module 110 mounted to the localization module interface 306, where the localization module 110 includes a line of sight localization component.

An example inspection robot 100, 200, 700 includes a motive power module 104 including: a motive power device and a magnetic engagement device; a first drive module on a first side, the first drive module including a motive power device and a first magnetic engagement device; a second drive module on a second side, the second drive module including a second magnetic engagement device; and an encoder coupled to a bottom of a housing of the motive power module, and configured to engage an inspection surface. The example inspection robot 100, 200, 700 further includes a core module 102 coupled to the motive power module 104, including a tether connection, a peripheral module interface, a power management component, and a data acquisition (DAQ) module interface, and where he core module provide power to the motive power device. An example inspection robot 100, 200, 700 further includes a differential 708 coupling the first drive module to the second drive module, wherein the differential 708 is positioned below the housing. An example differential 708 is configured to enforce a rotational transform between the first drive module and the second drive module. An example differential is configured to enforce two axes of rotational transform between the first drive module and the second drive module. An example first axis of the rotation transform includes an elevational rotation, or a rotation of the type that occurs when a front wheel or tracked portion is raised or lowered separately from the rear wheel or tracked portion. An example second axis of the rotation transform includes a droop rotation, or a rotation of the type that occurs when the wheels on one side both lower. In certain embodiments, the differential 708 enforces the rotational transform between the drive modules in one or both axes, and/or in another axis of interest (e.g., a yaw axis).

An example inspection robot 100, 200, 700 includes a motive power module 104 including a motive power device, a magnetic engagement device; a core module coupled to the motive power module, including a tether connection, a peripheral module interface, a power management component, and a data acquisition (DAQ) module interface, where the core module includes a housing having a leak test port, and where the core module 102 provides power to the motive power device. An example leak test port is configured to receive a sealing plug (e.g., coupled to a transducer) during a leak test operation. An example leak test port is configured to receive a dessicant cartridge during an inspection operation.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems herein. The terms computer, computing device, processor, circuit, and/or server, (“computing device”) as utilized herein, should be understood broadly.

An example computing device includes a computer of any type, capable to access instructions stored in communication thereto such as upon a non-transient computer readable medium, whereupon the computer performs operations of the computing device upon executing the instructions. In certain embodiments, such instructions themselves comprise a computing device. Additionally or alternatively, a computing device may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware and/or computing devices include, without limitation, a general-purpose computer, a server, an embedded computer, a mobile device, a virtual machine, and/or an emulated computing device. A computing device may be a distributed resource included as an aspect of several devices, included as an interoperable set of resources to perform described functions of the computing device, such that the distributed resources function together to perform the operations of the computing device. In certain embodiments, each computing device may be on separate hardware, and/or one or more hardware devices may include aspects of more than one computing device, for example as separately executable instructions stored on the device, and/or as logically partitioned aspects of a set of executable instructions, with some aspects comprising a part of one of a first computing device, and some aspects comprising a part of another of the computing devices.

A computing device may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer-to-peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information (“receiving data”). Operations to receive data include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first receiving operation may be performed, and when communications are restored an updated receiving operation may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g., where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The methods and/or processes described above, and steps thereof, may be realized in hardware, program code, instructions, and/or programs or any combination of hardware and methods, program code, instructions, and/or programs suitable for a particular application. The hardware may include a dedicated computing device or specific computing device, a particular aspect or component of a specific computing device, and/or an arrangement of hardware components and/or logical circuits to perform one or more of the operations of a method and/or system. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above, and combinations thereof, may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer readable instructions described above. All such permutations and combinations are intended to fall within the scope of the present disclosure.

While the disclosure has been disclosed in connection with certain embodiments shown and described in detail, various modifications and improvements thereon will become readily apparent to those skilled in the art. Accordingly, the present disclosure is not to be limited by the specific examples described and depicted, but is to be understood in the broadest sense allowable by law.

What is claimed is:

1. An inspection robot, comprising:
a motive power module comprising a motive power device and a magnetic engagement device, coupled to a core module comprising a tether connection, a peripheral module interface, a power management component, and a data acquisition (DAQ) module interface;
a peripheral module coupled to the peripheral module interface, the peripheral module comprising power coupling and communications coupling, and for a selected payload; and
a DAQ module coupled to the DAQ module interface, the DAQ module comprising a data acquisition circuit configured to collect, store, and/or transmit data from the selected payload to an external device.

2. The inspection robot of claim 1, wherein the core module is configured to communicatively couple the payload with the data acquisition circuit.

3. The inspection robot of claim 1, wherein the core module comprises a network communication circuit structured to perform at least a portion of the transmitting data to the external device.

4. The inspection robot of claim 1, wherein the magnetic engagement device comprises a plurality of magnetic wheels driven by at least one electric motor.

5. The inspection robot of claim 1, wherein the motive power module comprises a chassis, and wherein the core module is mounted on the chassis.

6. The inspection robot of claim 1, wherein the motive power module and the coupled core module comprise a base robot configuration.

7. The inspection robot of claim 1, wherein the payload comprises a camera.

8. The inspection robot of claim 1, wherein the payload comprises an electromagnetic sensor.

9. The inspection robot of claim 1, wherein the payload comprises an ultrasonic (UT) sensor.

10. The inspection robot of claim 9, wherein the peripheral module interface further comprises a couplant interface.

11. The inspection robot of claim 1, wherein the peripheral module interface and the DAQ module interface are on a topside of the core module.

12. The inspection robot of claim 11, wherein the peripheral module interface is more forward than the DAQ module interface.

13. The inspection robot of claim 12, wherein the peripheral module interface comprises a keying assembly configured to ensure that only a peripheral module can be mounted on the peripheral module interface.

14. The inspection robot of claim 13, wherein the DAQ module interface comprises a second keying assembly configured to ensure that only a DAQ module can be mounted on the DAQ module interface.

15. The inspection robot of claim 1, wherein the core module further comprises a localization module interface.

16. The inspection robot of claim 15, wherein the peripheral module interface, the DAQ module interface, and the localization module interface are on a topside of the core module.

17. The inspection robot of claim 16, wherein the interfaces are positioned, in order from front to back, as the peripheral module interface, the DAQ module interface, and the localization module interface.

18. The inspection robot of claim 17, wherein the peripheral module interface comprises a keying assembly configured to ensure that only a peripheral module can be mounted on the peripheral module interface.

19. The inspection robot of claim 17, wherein the DAQ module interface comprises a second keying assembly configured to ensure that only a DAQ module can be mounted on the DAQ module interface.

20. The inspection robot of claim 19, wherein the localization module interface comprises a third keying assembly configured to ensure that only a localization module can be mounted on the localization module interface.

21. The inspection robot of claim 15, wherein the localization module comprises a line of sight localization component.

22. The inspection robot of claim 21, wherein the line of sight localization component comprises a robotic total station prism.

23. The inspection robot of claim 21, wherein the line of sight localization component comprises a LiDAR component.

24. The inspection robot of claim 21, wherein the line of sight localization component comprises a WiFi ranging component.

25. The inspection robot of claim 21, wherein the line of sight localization component comprises a camera.

26. An inspection robot, comprising:
a motive power module comprising a motive power device, a magnetic engagement device, and a housing defining the motive power device, the housing comprising cooling fins;
a core module coupled to the motive power module, comprising a tether connection, a peripheral module interface, a power management component, and a data acquisition (DAQ) module interface; and
wherein the core module provides power to the motive power device.

27. The inspection robot of claim 26, further comprising:
wherein the peripheral module interface comprises a power coupling, a communications coupling, and a couplant coupling; and
a payload module comprising an ultrasonic sensor on a payload, coupled to the peripheral module interface.

28. The inspection robot of claim 26, further comprising a second housing defining the core module, wherein the second housing further comprises cooling fins.

29. The inspection robot of claim 28, further comprising a thermal electric cooler interposed between a heat generating component of the core module and the second housing.

30. The inspection robot of claim 29, wherein the heat generating component comprises a printed circuit board.

31. The inspection robot of claim 29, wherein the heat generating component comprises a power electronics component.

32. The inspection robot of claim 28, wherein the second housing further comprises a leak test port.

33. The inspection robot of claim 26, wherein the motive power device comprises a tracked motive power device.

34. The inspection robot of claim 33, wherein the tracked motive power device comprises a trapezoidal form factor.

35. The inspection robot of claim 34, wherein the motive power module further comprises a ride adjusting actuator configured to adjust the trapezoidal form factor.

36. The inspection robot of claim 35, wherein the adjustment to the trapezoidal form factor comprises at least one of:
adjusting a short leg length;
adjusting a ramp height; or
adjusting a ramp angle.

37. The inspection robot of claim 26, wherein the motive power module further comprises:
a first drive module on a first side, the first drive module comprising the motive power device and the magnetic engagement device;
a second drive module on a second side, the second drive module comprising a second magnetic engagement device; and
a differential coupling the first drive module to the second drive module, wherein the differential is positioned below the housing.

38. The inspection robot of claim 37, further comprising an encoder coupled to the bottom of the housing, and configured to engage an inspection surface.

39. The inspection robot of claim 38, wherein the encoder is mounted on a gas spring.

40. An inspection robot, comprising:
a motive power module comprising a motive power device and a magnetic engagement device;
a core module coupled to the motive power module, the core module comprising a peripheral module interface, a data acquisition (DAQ) module interface;
wherein the peripheral module interface comprises a keying assembly configured to ensure that only a peripheral module can be mounted on the peripheral module interface.

41. The inspection robot of claim 40, wherein the peripheral module interface and the DAQ module interface are on a topside of the core module.

42. The inspection robot of claim 41, wherein the peripheral module interface is more forward than the DAQ module interface.

43. The inspection robot of claim 42, wherein the DAQ module interface comprises a second keying assembly configured to ensure that only a DAQ module can be mounted on the DAQ module interface.

44. The inspection robot of claim 40, wherein the core module further comprises a localization module interface.

45. The inspection robot of claim 44, wherein the peripheral module interface, the DAQ module interface, and the localization module interface are on a topside of the core module.

46. The inspection robot of claim 45, wherein the interfaces are positioned, in order from front to back, as the peripheral module interface, the DAQ module interface, and the localization module interface.

47. The inspection robot of claim 46, wherein the DAQ module interface comprises a second keying assembly configured to ensure that only a DAQ module can be mounted on the DAQ module interface.

48. The inspection robot of claim 47, wherein the localization module interface comprises a third keying assembly configured to ensure that only a localization module can be mounted on the localization module interface.

49. The inspection robot of claim 44, wherein the localization module comprises a line of sight localization component.

50. The inspection robot of claim 49, wherein the line of sight localization component comprises a robotic total station prism.

51. The inspection robot of claim 49, wherein the line of sight localization component comprises a LiDAR component.

52. The inspection robot of claim 49, wherein the line of sight localization component comprises a WiFi ranging component.

53. The inspection robot of claim 49, wherein the line of sight localization component comprises a camera.

54. An inspection robot, comprising:
a motive power module comprising a motive power device and a magnetic engagement device, coupled to a core module comprising a tether connection, a peripheral module interface, a power management component, a data acquisition (DAQ) module interface, and a localization module interface; and
a localization module mounted to the localization module interface, wherein the localization module comprises a line of sight localization component.

55. The inspection robot of claim 54, wherein the peripheral module interface, the DAQ module interface, and the localization module interface are on a topside of the core module.

56. The inspection robot of claim 55, wherein the peripheral module interface, the DAQ module interface, and the localization module interface are on a topside of the core module.

57. The inspection robot of claim 56, wherein the interfaces are positioned, in order from front to back, as the peripheral module interface, the DAQ module interface, and the localization module interface.

58. The inspection robot of claim 57, wherein the localization module interface comprises a keying assembly configured to ensure that only a localization module can be mounted on the localization module interface.

59. The inspection robot of claim 57, wherein the line of sight localization component comprises a robotic total station prism.

60. The inspection robot of claim 57, wherein the line of sight localization component comprises a LiDAR component.

61. The inspection robot of claim 57, wherein the line of sight localization component comprises a WiFi ranging component.

62. The inspection robot of claim 57, wherein the line of sight localization component comprises a camera.

63. An inspection robot, comprising:
a motive power module comprising a tracked motive power device and a magnetic engagement device;
a core module coupled to the motive power module, comprising a tether connection, a peripheral module interface, a power management component, and a data acquisition (DAQ) module interface; and
wherein the core module provides power to the motive power device.

64. The inspection robot of claim 63, wherein the tracked motive power device comprises a trapezoidal form factor.

65. The inspection robot of claim 64, wherein the motive power module further comprises a ride adjusting actuator configured to adjust the trapezoidal form factor.

66. The inspection robot of claim 65, wherein the adjustment to the trapezoidal form factor comprises adjusting a short leg length.

67. The inspection robot of claim 65, wherein the adjustment to the trapezoidal form factor comprises adjusting a ramp height.

68. The inspection robot of claim 65, wherein the adjustment to the trapezoidal form factor comprises adjusting a ramp angle.

69. The inspection robot of claim 65, wherein the adjustment to the trapezoidal form factor comprises adjusting a long leg length.

70. The inspection robot of claim 65, wherein the adjustment to the trapezoidal form factor comprises adjusting a diagonal characteristic ratio.

71. The inspection robot of claim 65, wherein the adjustment to the trapezoidal form factor comprises adjusting a leading ramp height.

72. The inspection robot of claim 65, wherein the adjustment to the trapezoidal form factor comprises adjusting a leading ramp angle.

73. An inspection robot, comprising:
a motive power module comprising:
a motive power device and a magnetic engagement device;
a first drive module on a first side, the first drive module comprising a motive power device and a first magnetic engagement device;
a second drive module on a second side, the second drive module comprising a second magnetic engagement device; and
an encoder coupled to a bottom of a housing of the motive power module, and configured to engage an inspection surface;
a core module coupled to the motive power module, comprising a tether connection, a peripheral module interface, a power management component, and a data acquisition (DAQ) module interface; and
wherein the core module provides power to the motive power device.

74. The inspection robot of claim 73, further comprising a differential coupling the first drive module to the second drive module, wherein the differential is positioned below the housing.

75. The inspection robot of claim 74, wherein the differential is configured to enforce a rotational transform between the first drive module and the second drive module.

76. The inspection robot of claim 74, wherein the differential is configured to enforce two axes of rotational transform between the first drive module and the second drive module.

77. The inspection robot of claim 76, wherein a first axis of rotational transform comprises an elevational rotation.

78. The inspection robot of claim 77, wherein a second axis of rotational transform comprises a droop rotation.

79. The inspection robot of claim 73, wherein the encoder is mounted on a gas spring.

80. An inspection robot, comprising:
a motive power module comprising a motive power device, a magnetic engagement device;
a core module coupled to the motive power module, comprising a tether connection, a peripheral module interface, a power management component, and a data acquisition (DAQ) module interface, the core module comprising a housing having a leak test port; and
wherein the core module provides power to the motive power device.

81. The inspection robot of claim 80, wherein the leak test port is configured to receive a sealing plug during a leak test operation.

82. The inspection robot of claim 80, wherein the leak test port is configured to receive a dessicant cartridge during an inspection operation.
